(19) United States
(12) Patent Application Publication
(10) Pub. No.: US 2026/0154930 A1
(43) Pub. Date: Jun. 4, 2026

(54) SEGMENTING METHOD FOR DELIMITING OBJECTS AS SEGMENTS IN A PACKAGE IN AN X-RAY DIFFRACTION ANALYSIS

(71) Applicant: Smiths Detection Germany GmbH, Wiesbaden (DE)

(72) Inventors: Stephan REIN, Hamburg (DE); Jens-Peter SCHLOMKA, Hamburg (DE); Gabriel ZIENERT, Hamburg (DE); Holger FLECKENSTEIN, Hamburg (DE); Daniel Hirschmeier, Hamburg (DE)

(21) Appl. No.: 18/998,876

(22) PCT Filed: Jul. 27, 2023
(86) PCT No.: PCT/EP2023/070892

§ 371 Date: Dec. 17, 2025

(30) Foreign Application Priority Data
Jul. 28, 2022 (DE) 102022207748.2

(51) Int. Cl. G06V 10/26; G01V 5/22; G06T 7/12; G06V 10/74; G06V 10/762; G06V 20/60

(52) U.S. Cl. CPC G06V 10/26; G01V 5/22; G06T 7/12; G06V 10/761; G06V 10/762; G06V 20/60; G06T 2207/10116

(57) ABSTRACT

The present invention relates to a segmentation method for delimitating objects (O) as segments (S) in an item of baggage (B) during an X-ray diffraction analysis, comprising the following steps:
recording pulse transmission functions (20) for a large number of voxels (30) of the item of baggage (B),
comparing the recorded pulse transmission functions (20) with at least one specified material function (40) and generating a similarity value (50) as a comparison result,
selecting at least one voxel (30) as the starting voxel (32) based on the similarity values (50),
creating at least one voxel cluster (34) starting out from the at least one selected starting voxel (32) using a combination method comprising the following steps
   a) combining the starting voxel (32) with neighbouring voxels (33) in all spatial directions,
   b) determining the similarity value (50) with the at least one material function (40) for each of these combinations,
   c) adding to the voxel cluster (34) those neighbouring voxels (33) which produce an improvement of the similarity value (50),
   d) repeating steps a) to c) up to a termination criterion (60),
combining overlapping voxel clusters (34) into at least one segment (S), taking into account an increase in the similarity value (50) through the combination.

The present invention relates to a segmentation method for delimitating objects as segments in an item of baggage during an X-ray diffraction analysis and a computer program product for carrying out such a segmentation method.

It is known that in security-relevant environments, for example at an airport, items of baggage should be checked for the presence of unauthorised or hazardous objects. For example, these may be illegal materials such as drugs, cash or similar objects. It is also known that hazardous objects, for example objects which are made of an explosive material or contain such a material, should be reliably detected. In order to solve this problem, so-called transmission scanners for checked baggage are used, at airports for example, which can carry out a transmission scan of the items of baggage with the help of X-ray transmission or as a computer tomograph (CT).

However, with these transmission methods it is disadvantageous that information about the material detected can only be extracted to a very limited extent. Rather, this transmission scan substantially involves a check with regard to relevant forms, or forms which are defined as hazardous. Material information can only be obtained in a relatively imprecise way by means of these transmission methods, for example by indicating a material density or the effective nuclear charge.

In order to ensure that, in the event of an object being classified as an alarm object by the transmission scan, this does not have to be unnecessarily separated from a baggage handling system for a time-consuming manual check, further scanning devices are often provided in airports, in a two-stage process. One possibility for this involves diffraction scanners which can perform an X-ray diffraction analysis. In this case, it is no longer the transmission but the diffracted X-ray radiation that is determined, making it possible to deduce from this the specific materials of individual objects in the item of baggage. The disadvantage of X-ray diffraction analysis is that although it can provide material-specific information with very high accuracy, this is only possible if the scanning process is carried out relatively slowly in order to have a high amount of photons available for the diffraction analysis. However, this contradicts the usual requirement of a high throughput of baggage to be checked in a security-relevant area, for example an airport. Therefore, during an X-ray diffraction analysis, the known solutions attempt a compromise between the fastest possible scanning and the most accurate material-specific evaluation possible. The faster a scan is performed during an X-ray diffraction analysis, the fewer photons are contained in the individual voxels. As a result, the informative value at the level of the individual voxels is often reduced to such an extent that reasonable segmentation is no longer possible. In some cases therefore, attempts are made to extract a 3-dimensional data set from the 4-dimensional data so that evaluation is possible in principle, but this transformation results in the loss of data from the 4-dimensional data set. In the classification following segmentation, this can lead to poorer results and thus to an increased false alarm rate. It is therefore the object of the present invention to remedy, at least in part, the disadvantages described above. In particular, the object of the present invention is to obtain the most accurate possible delimitation of objects in an item of baggage in a cost-effective and simple manner.

The above object is achieved by a segmentation method with the features of claim 1 and a computer program product with the features of claim 14. Further features and details of the invention are disclosed in the dependent claims, the description and the drawings. Naturally, features and details described in connection with the segmentation method according to the invention also apply in connection with the computer program product according to the invention and vice versa, so that with regard to disclosure mutual reference is or can always be made to the individual aspects of the invention.

According to the invention, a segmentation method is proposed for delimitating objects as segments in an item of baggage during an X-ray diffraction analysis, comprising the following steps:
recording pulse transmission functions for a large number of voxels of the item of baggage,
comparing the recorded pulse transmission functions with at least one specified material function and generating a similarity value as a comparison result,
selecting at least one voxel as the starting voxel based on the similarity values,
creating at least one voxel cluster starting out from the at least one selected starting voxel using a combination method comprising the following steps:
   a) combining the starting voxel with neighbouring voxels in all spatial directions,
   b) determining the similarity value with the at least one material function for each of these combinations,
   c) adding to the voxel cluster those neighbouring voxels which produce an improvement and/or maintenance of the similarity value,
   d) repeating steps a) to c) up to a termination criterion,
combining overlapping voxel clusters into at least one segment, taking into account an increase in the similarity value through the combination.

The core idea of the invention is based on utilising all data, especially in a 4-dimensional data set, for segmentation and nonetheless carrying out a segmentation in a material-specific manner with a high degree of accuracy, even with a low number of photons. This is made possible in that, contrary to the known solutions, no reduction into a 3-dimensional data set takes place; rather, the segmentation is based directly on the data obtained from the diffraction analysis. In order to compensate for the lack of photons in the individual voxels, a targeted combination of individual voxels is carried out, so that the voxel clusters created in this way are based on a larger number of photons compared to individual voxels and accordingly also allow a more precise segmentation. At the same time, these steps preserve the information content of the 4-dimensional data. The arrangement according to the invention is based on the core idea that a pulse transmission function is specific to a particular material. The pulse transmission function is recorded individually for preferably all individual spatial volumes of the item of baggage, i.e. preferably all voxels of the item of baggage. The resolution of the voxels can be chosen differently depending on requirements. The larger the chosen size of the respective voxel, the higher the photon number for this larger voxel at the same scanning speed, but the less accurate the resolution in the subsequent segmentation.

Preferably, when recording pulse transmission functions, this step is carried out for a large number of identical or substantially identical voxels. This is to be understood to mean that all voxels have an identical or substantially identical form and/or size. At the end of this first step, there is now a pulse transmission function for any number of voxels. These pulse transmission functions, for example, in the case of 1000 voxels, likewise 1000 pulse transmission functions, can now be compared with at least one specified material function in a second step of a method according to the invention.

In the sense of the present invention, a material function is a pulse transmission function specific to a particular material. For example, for a large number of different materials or material compositions, a correspondingly large number of material functions specific to these compositions may be stored in a data library. The appropriate material function for the comparison step can then be selected from this data library. For example, a search for a specific explosive can be carried out so that, for such a specific explosive material, the corresponding material function for this specific explosive material is selected from such a material library and specified for the comparison. In the comparison step, the pulse transmission functions of all voxels are now checked for similarity to this specified material function. This is preferably a mathematical comparison, so that a similarity value between each pulse transmission function and the specified material function is generated in a qualitative, but also in a quantitative way, as a comparison result. In particular, vectors of the pulse transmission function and the material function are compared with each other. The result of such a vector comparison can for example be a scalar value and can in particular be compared with a limit value. The comparison result can indicate, qualitatively or quantitatively, the relationship to such a limit value. For example, a qualitative similarity value can assume the values “1” for “similar” and “O” for “dissimilar”. A quantitative formation of the similarity value can assume the degree of similarity, for example, between a maximum for “identical” and a minimum for “completely different”. In other words, this comparison step entails a comparison result that provides an indication, for each individual voxel for which a pulse transmission function has been recorded, of whether and/or to what extent there is a similarity to the at least one specified material function. In other words, it can indicate in which voxels the material being searched for is, with a certain probability, present, and in which voxels this is not the case.

However, due to a preference for fast scanning, which is often specified as a technical requirement, this comparison step is still subject to a high degree of inaccuracy since, due to the fast scanning process during the X-ray diffraction analysis, only a very small number of photons could be registered for each individual voxel. In order to avoid a false alarm and at the same time to minimise an undesirable non-recognition of relevant material, the segmentation method according to the invention goes further in that all voxels which have a certain degree of similarity to the material function are selected as starting voxels. This can be a purely qualitative selection, but also a quantitative selection. Preferably, as will be explained later, each similarity value for each individual voxel is a single scalar value, so that a very simple distinction can be made between similarity and dissimilarity to the specified material function.

The distinction between similar and dissimilar voxels, and in this way a selection of the starting voxels, now leads to a combination method integrated into the segmentation method which can also be referred to as a region-growing method. The term region-growing method is used here because, starting out from the individual voxels defined as starting voxels, growth and a combination with other neighbouring voxels can take place, as will be explained below.

Each starting voxel was therefore selected as such because it fulfils a certain minimum similarity, defined by the comparison result and thus by the similarity value with respect to the material function. Now a check is carried out for each starting voxel to determine whether it can be combined with the neighbouring voxels. In other words, the starting voxel is first combined with a first neighbouring voxel, thus doubling the volume of the combination to be checked. Of course, this also leads to an increase in the number of photons to be checked, which form the basis for this step. Accordingly, the combination of starting voxel and neighbouring voxels results in a pulse transmission function specific to this combination, for which a similarity value can also be recorded according to the aforementioned comparison step. This similarity value again allows an indication as to whether or not this combination shows a similarity to the material function (qualitative statement), or even, quantitatively, whether the similarity increases, remains the same or decreases through this combination. Accordingly, in a three-dimensional check of a spatial volume, starting from a starting voxel there are up to 26 neighbouring voxels, all of which are checked individually with regard to this combination, so that subsequently, in step c) of the combination method, those neighbouring voxels are combined with the starting voxel to form a voxel cluster that match the specified material function due to the determined similarity value. The neighbouring voxels that do not match this material function are excluded and thus defined as not belonging to this voxel cluster. These steps of combination with neighbouring voxels and the resulting further growth of the voxel cluster are carried out until a termination criterion is reached, which will be explained in more detail later. In the simplest case, this termination criterion can be a maximum number of iterations, but it can also include a substantive evaluation of the quality of this growth and/or the similarity values. It should be pointed out at this point that of course the resulting voxel cluster in each case then goes through the steps a), b) and c) with regard to all neighbouring voxels, so that the number of neighbouring voxels for the combination and for the determination of the similarity values also increases for each iteration run of this combination method.

As a result, at least one voxel cluster, in practice usually a large number of separate voxel clusters, which can differ from each other, but can also overlap, is created. The voxel clusters can be interpreted as connected voxels that have a minimum degree of similarity to the material function, and are therefore most likely part of an object that actually comprises the specific material in relation to the specified material function. This has the great advantage that, not only a single voxel, but a specifically selected combination of several voxels as a voxel cluster can now be used as the basis for each voxel cluster, which in this way, with a significantly increased number of photons, results in a significantly increased accuracy of the correlation to the specified material function, and thus a high probability that a hazardous material can be detected and can be distinguished from a non-hazardous material.

In a final step of the segmentation method according to the invention, a final combination of the overlapping voxel clusters into at least one segment takes place. In other words, after the step of growing starting voxels, which can also be called seeds, all voxel clusters based and grown on these seeds are combined with each other as long as they overlap and as long as they correlate with the identical material function. In this way, the voxel clusters are combined, like individual, overlapping puzzle pieces, to form a segment which can finally be differentiated, as an independent object, from other segments or other objects within the item of baggage and defined.

As can be seen from the previous explanation, a method according to the invention is still based on a clear and specific comparability of a pulse transmission function during an X-ray diffraction analysis with a corresponding material function specific to a material. However, the disadvantages of the low number of photons for each voxel are reduced in the evaluation method in that, in the first part of the method, an assignment of each voxel to the material is carried out and, through an optimisation problem, and thus an algorithmic iteration in the form of the generation of the voxel clusters, an enlargement of those identified relevant starting voxels takes place which actually lead, during the combination and thus the growth of the individual seed voxels, to a voxel cluster. On the other hand, starting voxels whose neighbouring voxels do not lead to an increase in the similarity values with respect to the material function are excluded again or lead to very small voxel clusters which, accordingly, are excluded in the final step of the combination into segments. This procedure allows the segmentation to be carried out using all the information of the 4-dimensional data while still obtaining segments of high accuracy through the targeted and optimised combination. At a given scanning speed, a maximised evaluation during the course of the segmentation is thus possible. A further acceleration of the scanning process may even be possible, since the further reduction in the number of photons can be at least partially compensated for by the combination during the segmentation according to the invention. This leads to more accurate subsequent classification and/or a reduction in undesired false alarms.

It may be advantageous if, in a segmentation method according to the invention, at least one of the following is used as the termination criterion for the combination method:
default number of iterations
lack of improvement of the similarity value through steps a) and b)
deterioration of the similarity value through steps a) and b)

In the simplest case, growth occurs up to a maximum value of for example three or four iterations. This is a particularly simple and above all precisely defined, in terms of the required computing time, specification of a termination criterion. However, for increased accuracy, more complex termination criteria can also be used, which in particular consider the development of the similarity values through the combination. For example, whenever the similarity value no longer improves, the process can be terminated, because the added or pending neighbouring voxel would no longer lead to an improvement and thus no longer to an increase in similarity to the material function. An even stronger termination criterion is if the combination would actually lead to a deterioration of the similarity values, i.e. a combination with a neighbouring voxel would reduce the similarity value and thus also reduce the similarity to the specified material function. A maximum number of voxels in the voxel cluster can also serve as a termination criterion and/or an exclusion of all neighbouring voxels from the combination. The iteration is therefore terminated if no improvement or even a deterioration of the similarity values is defined for all neighbouring voxels checked for combination, so that not a single neighbouring voxel remains for a combination and, accordingly, the iteration steps and the iteration loop can be defined as being terminated here.

It is also advantageous if, in a segmentation method according to the invention, the generated voxel clusters are sorted according to their similarity value before the step of combining them into at least one segment. In other words, the voxel clusters are sorted in such a way that the combination starts with those voxel clusters that seem most promising for the combination. This means that the combination to form the at least one segment can then be carried out on the basis of this sorting, i.e. the voxel clusters with the greatest similarity values are taken into consideration in a first step and then, with decreasing similarity values, the other voxel clusters. This leads to a faster combination and can in addition improve this final step of combination.

Further advantages are achievable if, in a segmentation method according to the invention, a group of several adjacent voxels is selected as starting voxels. In addition to individual starting voxels, such a starting voxel group can also be defined, in particular if the scan of the X-ray diffraction analysis has been carried out so quickly that the individual voxels have such a low photon density that a reasonable comparison in order to generate the similarity values is not possible. This step can also be understood to mean that the size of the individual voxels is increased to such an extent that the small initial voxels are enlarged into enlarged final voxels, which then, as a starting voxel group according to the present invention, again allow a single, now enlarged starting voxel for the performance of the method according to the invention. This size or grouping can preferably be adaptable, in particular to the size of the voxels and/or the scanning speed when performing the X-ray diffraction analysis.

In addition, it brings advantages if, in a segmentation method according to the invention, after combining overlapping voxel clusters into a segment, this step is repeated with the remaining voxel clusters. The remaining voxel clusters are voxel clusters which do not overlap with the voxel clusters of the first step of combining, but are unconnected with them. In other words, these may be other objects which, comprising the same material, led to their being joined to the voxel cluster. In principle, the size of the voxel clusters can also be taken into account, i.e. whether the step of combining should also be carried out again for these, or whether they should be discarded as being too small. With this addition, it is also possible to detect two or more objects with the identical material function similarity. At this point it should be pointed out once again that the method according to the invention can of course also be carried out separately for two or more different material functions. In particular, if there is no indication as to which specific material may be present in the item of baggage, a very broad analysis can be carried out here, so that not only two, but even a large number of different material functions are specified and the method according to the invention can carry out the steps, and thus the recognition of a segmentation of objects, for a large number of different specified material functions. It also brings advantages if, in a segmentation method according to the invention, the similarity value is formed as a scalar value. Such a scalar value can, for example, form a single and thus very simple comparable parameter and can be the result of the vector comparison already described. The optimisation steps with regard to the iteration, as well as the comparison steps during the course of the segmentation method according to the invention, thus become clearer and are above all optimised in terms of the computational effort required.

In addition, it can be advantageous if, in a segmentation method according to the invention, similarity values can be used for at least two different material functions. As has already been explained, these similarity values can be carried out sequentially, one after the other, so that an evaluation can be carried out on different materials simultaneously or sequentially. In particular, this integrates an exclusion of voxels and voxel clusters which have been assigned to a material so that, in order to avoid double comparisons, for the run with a second specified material function, only those voxels are passed on to the segmentation method according to the invention which are left over from the first segmentation method. It also brings advantages if, in a segmentation method according to the invention, the at least one material function is specified on the basis of a scanning result of a preceding scanning method. Such a preceding scanning method could in particular be an X-ray transmission method.

Basically, information, for example about the density of individual objects, can be obtained from such transmission methods, so that basic information is contained indicating which material might be involved. However, this information is not so precise that an alarm can be triggered or ruled out. Rather, this means that in the case of a system combination (system of system), all items of baggage are scanned using such a very fast transmission method. Items of baggage that are identified as being potentially hazardous because they may contain alarm objects, and only such identified items of baggage, are then fed into the X-ray diffraction analysis, so that the X-ray diffraction analysis only has to deal with a proportion of all items of baggage. In order to make the X-ray diffraction analysis, which generally works much more slowly than the transmission technology, work even more accurately and more quickly, the information regarding the material possibly present in the item of baggage can be selected for evaluation when performing a segmentation method according to the invention, so that the material class or even one or more defined specified material functions are specified in accordance with the first scanning result.

It brings further advantages if, in a segmentation method according to the invention, the steps are limited to a self-contained area of the item of baggage. In other words, a partial area of an item of baggage can for example be defined as an area containing an alarm object, so that while the scanning process with X-ray diffraction analysis is performed in full or at least for the disc-shaped part of the item of baggage in which the object is arranged, the analysis is carried out only for a partial area and only a part of the voxels in the item of baggage.

In addition, it can have advantages if, in a segmentation method according to the invention, an alarm signal is output and/or an existing alarm signal is cancelled, depending on the combination into at least one segment. If the segmentation method is used in a standalone system with X-ray diffraction analysis, then an alarm signal can be generated or suppressed depending on whether an object has been segmented, is large enough and corresponds to a corresponding material function in terms of the similarity values. However, it is preferable if such an X-ray diffraction analysis is used in combination with a preceding, fast-working transmission system and thus only serves to check items of luggage identified as being potentially hazardous. An alarm signal output by the first scan by a transmission device is thus either confirmed or cancelled by the X-ray diffraction analysis by means of a segmentation method according to the invention.

It is also advantageous if, in a segmentation method according to the invention, segment coordinates in a coordinate system of the item of baggage are determined for the at least one segment. In such a case, the coordinate system of the item of baggage is a relative coordinate system, so that the segment and an object related to this segment can be defined exactly within the item of baggage. This is in particular expedient if these segment coordinates are to be passed on to a manual evaluation together with the item of baggage or are to be transferred for further processing. The coordinate system of the item of baggage moves with the item of baggage, so that the segment relative to the item of baggage defines the object within this, regardless of the absolute orientation of the item of baggage. In addition to further analysis, this also allows an overlay with images that have been generated for the same item of baggage, for example using a different scanning device, for example a transmission device. In particular, this also allows a correlation with location-specific alarm signals for the respective item of baggage.

Further advantages can be achieved if, in a segmentation method according to the invention, at least one transmission segment has been generated by means of a preceding transmission method carried out on the same item of baggage, in particular in the form of a CT method (computed tomography method), the transmission segment coordinates of which are determined in the coordinate system of the item of baggage. This means that, so to speak, a transmission segmentation method, i.e. a segmentation method exclusively on the basis of the data of the transmission method, is carried out in order to carry out a segmentation for one or more objects within the item of baggage. A superimposition or even a further use and a comparison between the transmission segment and the segment of the segmentation method according to the invention can then take place. The simplest case is if the transmission segment for a segmentation method according to the invention is transferred as a label or designation into the evaluation of the X-ray diffraction analysis. However, more complex implementations are also conceivable in principle.

In addition, it brings advantages if, in a segmentation method according to the invention, information, in particular the boundaries of the transmission segment, is taken into account when generating the at least one voxel cluster and/or during the combination to form the at least one segment. Such a consideration allows an additional consideration to be achieved during the combination method, i.e. during the growth of the individual voxel clusters and/or during the combination of the voxel clusters to form one or more segments, so that the boundaries of the segment recognised in the transmission method can for example be taken into account as boundaries for the segmentation in the X-ray diffraction analysis. In the segmentation, a penalty term and/or a reward term, for example in a cost function, can for example allow such a consideration. For example, adherence to the segment boundaries from transmission during the segmentation through the X-ray diffraction analysis is mathematically rewarded. Likewise, a violation of the segment boundaries from the transmission during the segmentation through the X-ray diffraction analysis is punished, whereby in particular the accuracy of the X-ray diffraction analysis can be taken into account.

The subject matter of the present invention also includes a computer program product comprising commands which, when the program is run on a computer, cause this to carry out the steps of a segmentation method according to the invention. Thus, a computer program product according to the invention has the same advantages as have been explained in detail with reference to a segmentation method according to the invention.

Further advantages, features and details of the invention are explained in the following description, in which exemplary embodiments of the invention are described in detail with reference to the drawings. The features mentioned in the claims and in the description may in each case be essential to the invention, individually or in any combination. In each case schematically:

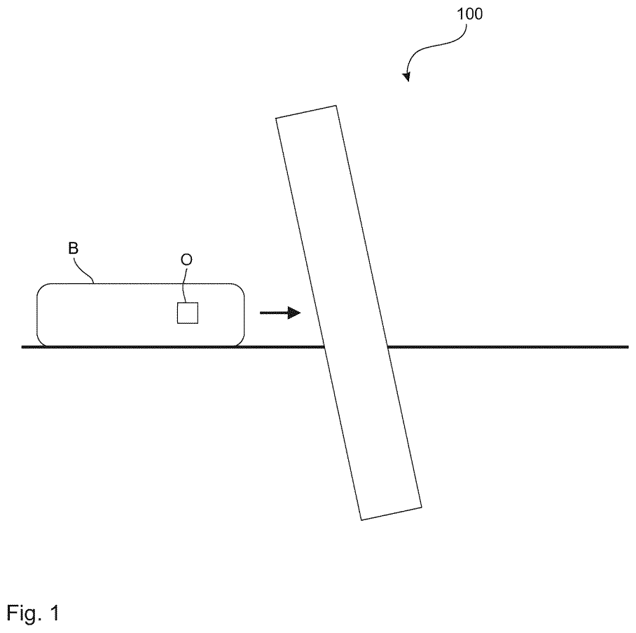

FIG. 1 shows an embodiment of a segmentation method according to the invention on an X-ray diffraction device,

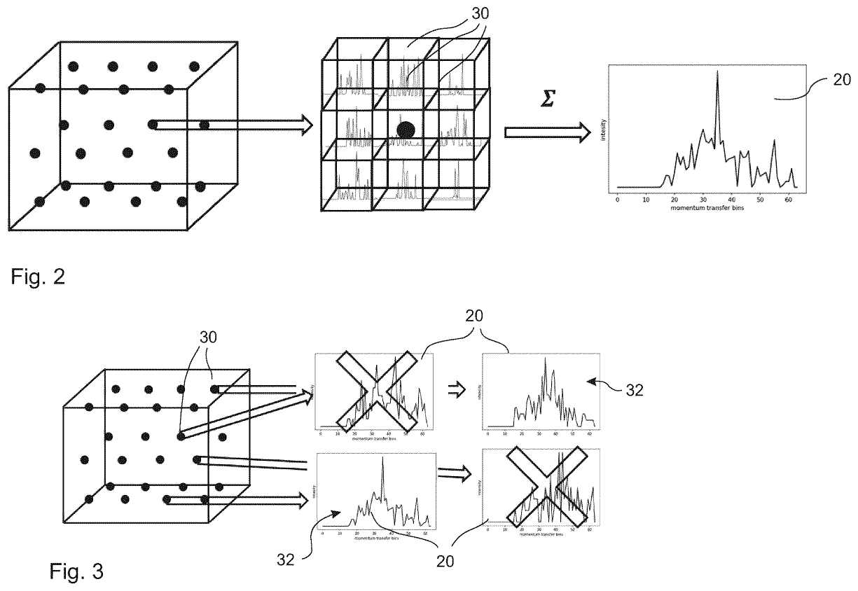

FIG. 2 shows a step of a segmentation method according to the invention,

FIG. 3 shows a further step of a segmentation method according to the invention,

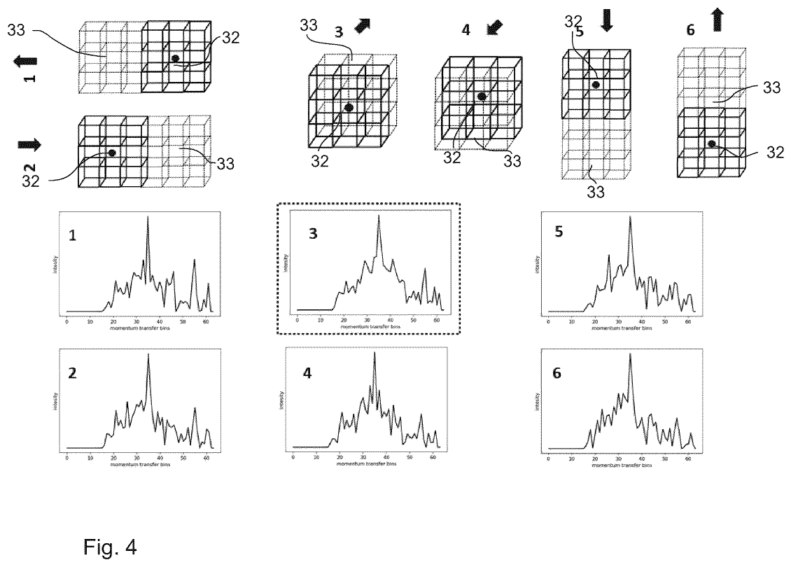

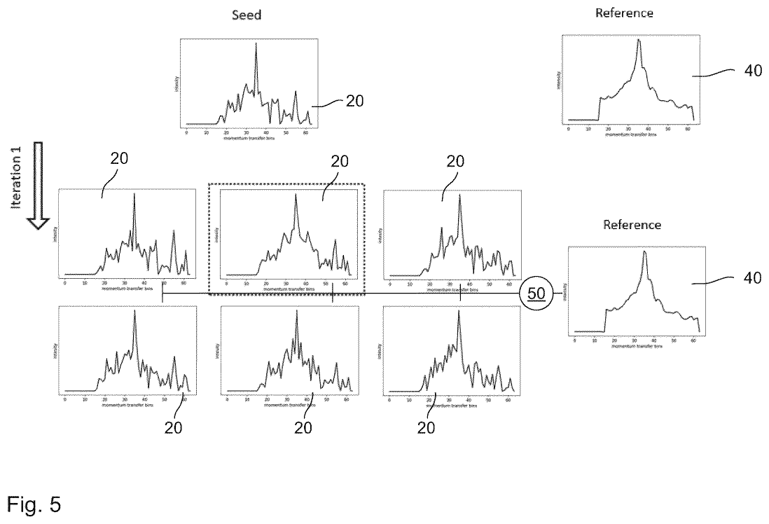

FIG. 4 shows a representation of the combination method,

FIG. 5 shows a first iteration step of the combination method,

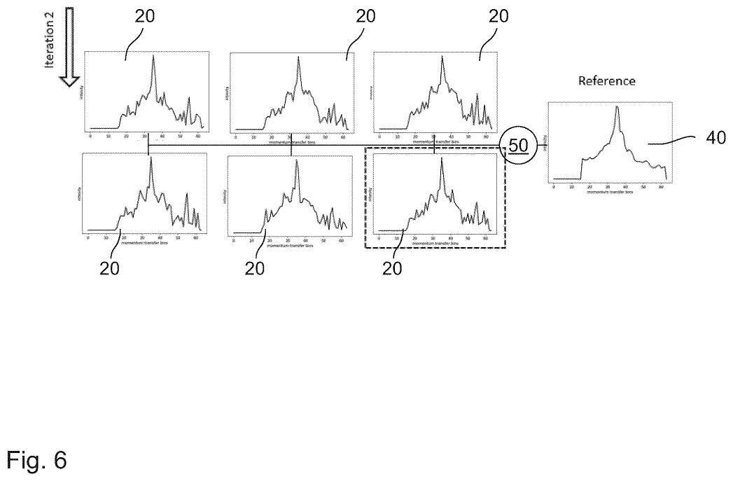

FIG. 6 shows a further iteration step of the combination method,

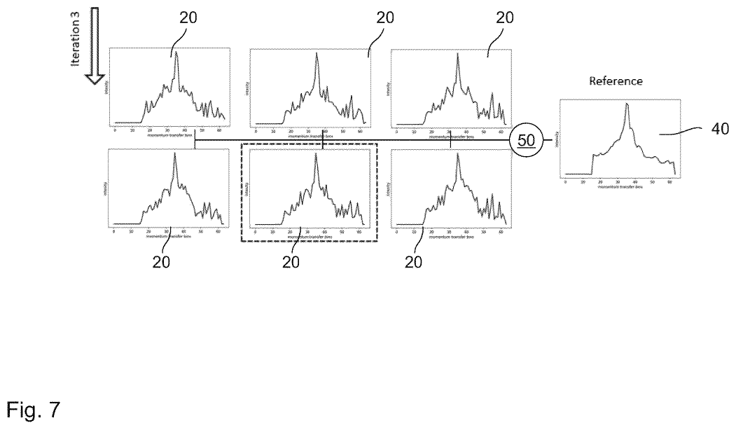

FIG. 7 shows a further iteration step of the combination method,

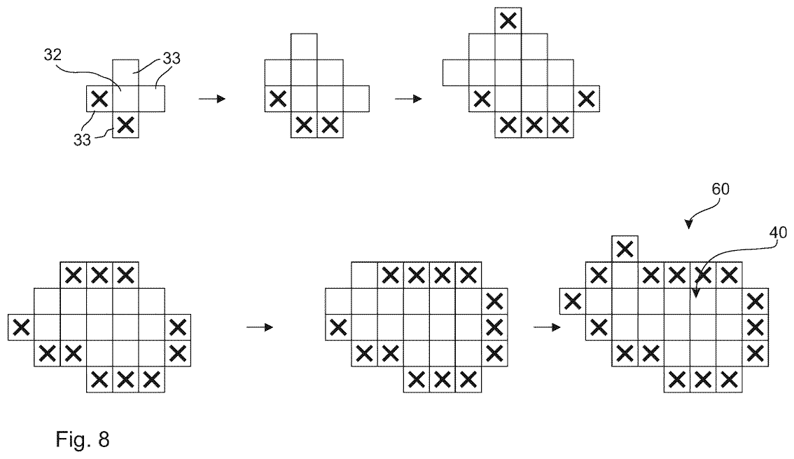

FIG. 8 shows a possible sequence in two-dimensional space for a combination method,

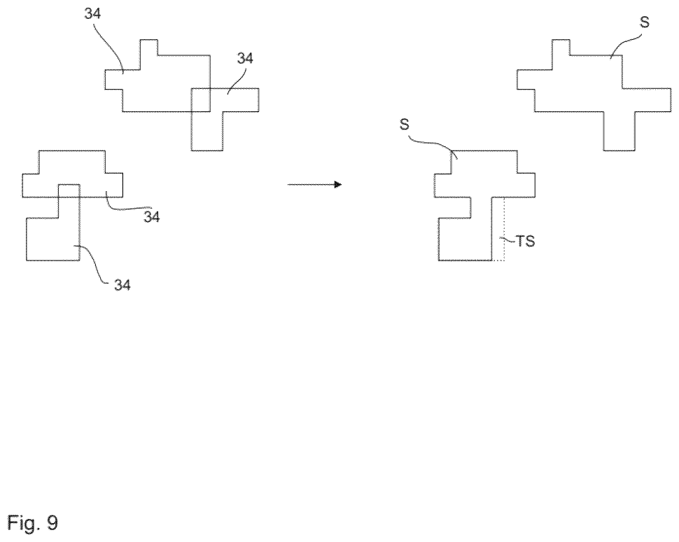

FIG. 9 shows the step of combining voxel clusters,

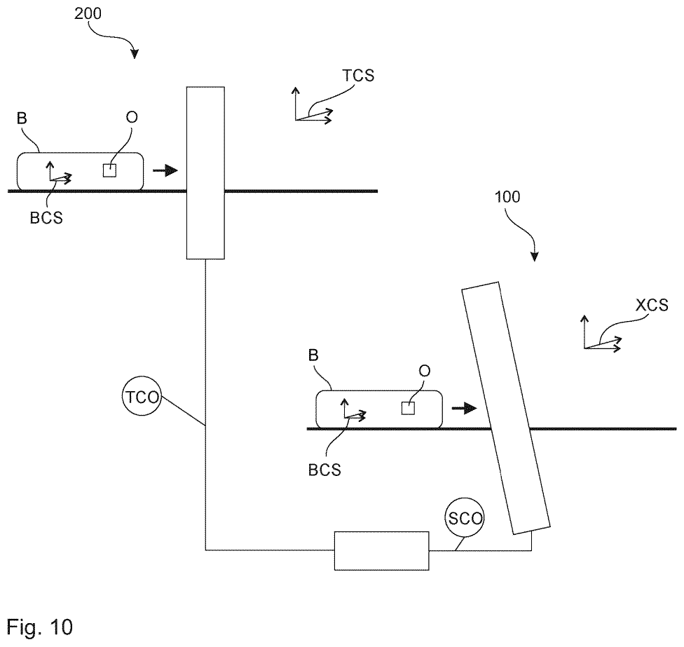

FIG. 10 shows a combination of a transmission device with an X-ray diffraction device.

FIG. 1 shows schematically how an X-ray diffraction device 100 can be constructed. Here, an item of baggage B is passed through an oblique scanning channel, through which diffracted X-rays can be detected in one or more detectors. Depending on the speed at which the item of baggage B travels through the X-ray diffraction device 100, more or fewer photons can be recorded in a diffracted form by the detectors per spatial volume, in the form of one or more voxels 30. In this representation, an object O is shown schematically as an alarm object which is for example to be detected as an explosive object by the X-ray diffraction device 100 with a high degree of certainty.

In order to be able to provide the most accurate evaluation possible through segmentation, in particular with a quick scan with the X-ray diffraction device 100 and the associated low number of photons per voxel 30, in a first step, as shown in FIG. 2, a pulse transmission function 20 is recorded for all individual voxels 30, i.e. all individual spatial volume elements, represented here schematically as a spatial cube. This pulse transmission function 20 is specific to each individual voxel 30 and yet is still relatively imprecise, since it is based on a very small number of photons at high scanning speeds.

In the next step, as FIG. 3 shows, the extent to which the pulse transmission functions 20 have a sufficient similarity to a material function 40 is now checked for each of these individual voxels 30, and if this is the case, they are defined as starting voxels 32. Voxels 30 with insufficient similarity are marked with an “X” and are excluded from the further method because they are sufficiently dissimilar to the specific material function 40. In particular, the similarity value 50, which will be explained later, can be used here, whereby in this first step it is still possible to work with a high level of imprecision due to the low photon density, i.e. a large number of starting voxels 30 can be selected as starting voxels 32 to increase reliability.

For each of these starting voxels 32, a combination method is now carried out, as explained in more detail below with reference to FIGS. 4, 5, 6 and 7. FIG. 4 shows how, from a single starting voxel 32, a neighbouring voxel 33 in each of the six spatial directions is checked to determine to what extent a combination with this neighbouring voxel 33 would lead to an improvement or a deterioration in a similarity value 50 to a material function 40. This is a regular spatial grid, whereby the steps according to the invention can of course also be used for irregular spatial divisions.

FIG. 5 shows a first iteration step. The seed cell, the starting voxel 32, has a single pulse transmission function 20 which was sufficiently similar to the material function 40 to be selected as the starting voxel 32. In the first iteration step of FIG. 5, a combination is now carried out with each of the six adjacent neighbouring voxels 33, so that they also form six different possible combinations of new combined pulse transmission functions 20 for the subsequent evaluation, all of which are compared with the material function 40 with regard to their similarity value 50. In the representation of FIG. 5, only one of the four combined pulse transmission functions 20 corresponds to a similarity value 50 which is large enough to be selected for the combination to the voxel cluster 34. FIG. 6 and FIG. 7 show further steps, whereby once again only a single neighbouring voxel 30 leads to a combined pulse transmission function 20, outlined at the bottom right in FIG. 6 and bottom centre in FIG. 7, which leads to a selection and addition to the voxel cluster 34.

FIG. 8 shows schematically what can result from the combination steps of FIGS. 5, 6 and 7. For the sake of simplicity, FIG. 8 is depicted two-dimensionally, whereby of course the functionality can and preferably should be three-dimensional. Starting from a single starting voxel 32 in the upper left, four neighbouring voxels 33 are checked in two-dimensional space, whereby only the two upper right neighbouring voxels 33 lead to a combined pulse transmission function 20 which has a sufficiently high similarity value 50. In the next steps, the enlargement continues, or individual neighbouring voxels 33 are excluded from the voxel cluster 34 due to a reduced similarity value 50, until a termination criterion 60 is reached. In the embodiment of FIG. 8, the termination criterion is reached if the voxel cluster 34 is completely surrounded by neighbouring voxels 33 that do not further increase the similarity value 50 or even lead to a combination whose combined pulse transmission function 20 would result in a reduction of the similarity value 50 with respect to the material function 40. This means that at least one voxel cluster 34 has been made available.

FIG. 9 shows how in this case two separate segments S are formed. In one step, or in a combined step, overlapping voxel clusters 34 are combined with each other to form individual and common segments S. These segments S are shown on the right-hand side. In the case of the lower segment S on the right-hand side in combined form, a correlation to a transmission segment TS can also be seen, so that a delimitation can be made as to whether the segment S actually found from the X-ray diffraction device 100 is smaller than or equal to a corresponding transmission segment TS which has been found in the transmission device 200, or is reduced in size.

FIG. 10 again shows a schematic combination of several systems as a so-called system of system arrangement. In a first step, all items of baggage B in an airport for example are scanned in a transmission device 200 and detected objects are localised, for example on the basis of their shape or their specific density, in a coordinate system of the item of baggage BCS. Here, a reverse transformation from the detection in the coordinate system of the transmission device TCS takes place.

Thus, the transmission segment coordinates TCO can be passed on to an evaluation device and can be taken into account in particular when performing a segmentation method according to the invention. Also when performing the segmentation method and scanning in the X-ray diffraction device 100, starting out from a detection in the coordinate system of the X-ray diffraction device XCS, the object O can be transformed back into segment coordinates SCO in the coordinate system of the item of baggage BCS through segmentation, so that a combined evaluation is possible.

The above explanation describes the present invention exclusively in the context of examples. Of course, individual features can, where technically expedient, be freely combined with each other without departing from the scope of the present invention.

### LIST OF REFERENCE SIGNS

20 pulse transmission function
30 voxels
32 starting voxels
33 neighbouring voxels
34 voxel cluster
40 material function
50 similarity value
60 termination criterion
100 X-ray diffraction device
200 transmission device
O object
S segment
TS transmission segment
B item of baggage
SCO segment coordinates
TCO transmission segment coordinates
BCS coordinate system of the item of baggage
TCS coordinate system of the transmission device
XCS coordinate system of the X-ray diffraction device

1. A segmentation method for delimitating objects as segments in an item of baggage during an X-ray diffraction analysis, the segmentation method comprising the following steps:
recording pulse transmission functions for a large number of voxels of the item of baggage,
comparing the recorded pulse transmission functions with at least one specified material function and generating a similarity value as a comparison result,
selecting at least one voxel as a starting voxel based on the similarity values,
creating at least one voxel cluster starting out from the at least one selected starting voxel using a combination method comprising the following steps
a) combining the starting voxel with neighboring voxels in all spatial directions,
b) determining the similarity value with the at least one material function for each of these combinations,
c) adding to the voxel cluster those neighboring voxels which produce an improvement and/or maintenance of the similarity value,
d) repeating steps a) to c) up to a termination criterion,
combining overlapping voxel clusters into at least one segment, taking into account an increase in the similarity value through the combination.

2. The segmentation method according to claim 1, wherein at least one of the following is used as termination criterion for the combination method:
default number of iterations
lack of improvement of the similarity value through steps a) and b)
deterioration of the similarity value through steps a) and b)

3. The segmentation method according to claim 1, wherein the generated voxel clusters are sorted according to their similarity value before the step of combining these into at least one segment.

4. The segmentation method according to claim 1, wherein a group of several adjacent voxels is selected as starting voxels.

5. The segmentation method according to claim 1, wherein after combining overlapping voxel clusters into a segment, this step is repeated with the remaining voxel clusters.

6. The segmentation method according to claim 1, wherein the similarity value is formed as a scalar value.

7. The segmentation method according to claim 1, wherein similarity values are used for at least two different material functions.

8. The segmentation method according to claim 1, wherein the at least one material function is specified on the basis of a scanning result of a preceding scanning method.

9. The segmentation method according to claim 1, wherein the steps are limited to a self-contained area of the item of baggage.

10. The segmentation method according to claim 1, wherein an alarm signal is output and/or an existing alarm signal is cancelled, depending on the combination into at least one segment.

11. The segmentation method according to claim 1, wherein segment coordinates in a coordinate system of the item of baggage are determined for the at least one segment.

12. The segmentation method according to claim 11, wherein at least one transmission segment has been generated by means of a preceding transmission method carried out on the same item of baggage, the transmission segment coordinates of which are determined in the coordinate system of the item of baggage.

13. The segmentation method according to claim 11, wherein information, in particular the boundaries of a transmission segment, is taken into account when generating the at least one voxel cluster and/or during the combination to form the at least one segment.

14. A non-transitory computer program product comprising computer-executable instructions which, when the program is executed by at least one processor of a computer, cause the at least one processor to carry out the steps of claim 1.
